(19) United States
(12) Patent Application Publication
(10) Pub. No.: US 2015/0332482 A1
(43) Pub. Date: Nov. 19, 2015

(54) DETECTING CONFORMANCE OF GRAPHICAL OUTPUT DATA FROM AN APPLICATION TO A CONVENTION

(71) Applicant: Microsoft Corporation, Redmond, WA (US)

(72) Inventors: Ali Sahibzada, Bellevue, WA (US); Alessandro Capistrano, Bellevue, WA (US)

(21) Appl. No.: 14/280,252

(22) Filed: May 16, 2014

(51) Int. Cl. G06T 11/00; G06F 17/21

(52) U.S. Cl. CPC G06T 11/001; G06F 17/214; G06T 2200/24

(57) ABSTRACT

Conformance of graphical output data from an application to a convention can be detected by processing instructions to render the graphical output data to determine if the graphical output data rendered in accordance with those instructions conforms to the convention. The graphical output data is then rendered based on this determination of conformance, such that the rendered graphical output data visibly differentiates conforming display data from nonconforming display data when presented on an output device. For example, text that conforms to specified font properties can be presented with one color, and text that is not conforming can be presented with another color.

### BACKGROUND

One of the many challenges in developing computer programs is ensuring that the resulting application provides a good user experience. For broadly distributed applications, providing a good user experience involves considering the many different languages and other capabilities of those users. However, software testing often cannot be performed economically by testers with the same breadth of capabilities as the likely user base.

One of the aspects of the user experience is the graphical output data of the application, such as display data in its graphical user interface or data output to a printer. Such graphical output data can include text, which when rendered is a combination of a character and font properties, such as type, size, weight and color. Other graphical output data can include images and other user interface elements. A developer may define conventions for this graphical output data, to ensure, for example, readability, visibility, and consistency with a theme or branding. Conformance to such conventions may not always occur due to the nature of computer programming and the fact that there may be different conventions for different markets and user types. Therefore, conformance to such conventions generally is verified, if at all, through testing.

Testing for conformance of graphical output data to conventions can be challenging for several reasons. A person may not be able to tell whether output text has a particular font size or other font properties. A person may not be able to tell whether the text is in a particular font type, especially if he or she is not familiar with the characters of the language of the text and how those characters should appear in a given font. A person also may not be able to tell the difference between two very similar colors. An output device also may not accurately present colors. Other characteristics of graphical output data also might not be visibly detectable by a person.

### SUMMARY

This Summary is provided to introduce a selection of concepts in a simplified form that are further described below in the Detailed Description. This Summary is intended neither to identify key or essential features, nor to limit the scope, of the claimed subject matter.

Conformance of graphical output data on an output device to a convention can be detected by processing instructions to render the graphical output data to determine if the graphical output data rendered in accordance with those instructions conforms to the convention. The graphical output data is then rendered based on this determination of conformance, such that the rendered graphical output data visibly differentiates conforming graphical output data from nonconforming graphical output data. For example, text that conforms to specified font properties, such as font type, size, weight, color, and other properties, can be presented in one color, and text that is not conforming can be presented with another color. This processing can occur within an application when that application renders graphical output data to be directed to an output device. This processing can occur within a renderer of an operating system of a computer, which renders graphical user interfaces for one or more applications for display, in some cases simultaneously, on one or more displays connected to the computer. Such processing can occur in other renderers that generate graphical output data for an application, such as for printing.

Conformance detection can be performed using a variety of techniques. For example, in one implementation, conformance detection can be performed using rule-based processing. In another implementation, a font file can be modified so as to provide glyph data in one color for text that is conforming, and to provide glyph data in another color for text that is nonconforming.

Accordingly, in one aspect, graphical data is received into memory. The graphical data includes instructions to render graphical output data. Data indicating conventions for rendered graphical output data also is received into memory. The instructions, included in the graphical data, are processed to determine if graphical output data rendered in accordance with those instructions conforms to the conventions. The graphical output data is then rendered in accordance with both those instructions and the determination made about conformance, such that the rendered graphical output data visibly differentiates conforming from nonconforming graphical output data when presented on an output device, such as being displayed on a display or printed on a printer.

In another aspect, a rendering module has an input to receive graphical data from a memory. The graphical data includes instructions to render graphical output data. The rendering module also has an input to receive data from the memory indicating conventions for rendered graphical output data. The rendering module processes the instructions to determine if graphical output data rendered in accordance with the instructions conforms to the conventions. The graphical output data is then rendered both in accordance with the instructions and based on the determination made about conformance, such that the rendered graphical output data visibly differentiates conforming from nonconforming graphical output data when presented on an output device, such as being displayed on a display or printed on a printer.

Processing can include rendering the instructions using a font file, wherein glyphs for set of font properties, such as types, sizes, weights and colors, conforming to the graphics conventions, are encoded in a color that, when rendered, indicate conformance to the user.

The graphical output data can include characters with a set of font properties and the conventions include acceptable font properties. For example, the display data can include characters in a font type (also called a face) and the conventions can include acceptable font types. The graphical output data can include characters in a font size and the conventions include acceptable font sizes. The graphical output data can include characters in a color, in which case the conventions include acceptable colors of characters. Other properties, such as weight, style, scaling factors, layers, names, and so on, also can be specified in a convention.

The graphical output data can be for a graphical user interface for an application or operating system on the computer. The instructions can be received from two or more applications on the computer, in which case, the processing can be performed for both applications by a display manager of an operating system. The graphical output data also can be directed to a printer or other output device, and can be for a purpose other than the graphical user interface of the application.

Information about any instructions to render graphical output data can be recorded if it is determined that the graphical output data does not conform to the conventions.

The invention may be embodied as a computer system, as any individual component of such a computer system, as a process performed by such a computer system or any individual component of such a computer system, or as an article of manufacture including computer storage with computer program instructions are stored and which, when processed by computers, configure those computers to provide such a computer system or any individual component of such a computer system.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example application environment in which a computer system supports verification of conformance of graphical output data to a convention.

FIG. 2 is a flowchart describing an example process of testing a graphical user interface.

FIG. 3 is a data flow diagram describing an example implementation.

FIG. 4 is a flowchart describing operation of the example implementation of FIG. 3.

FIG. 5 is a diagram of an example graphical user interface.

FIG. 6 is a data flow diagram describing an example implementation.

FIG. 7 is a flowchart describing operation of the example implementation of FIG. 6.

FIG. 8 is a block diagram of an example computer with which components of such a system can be implemented.

### DETAILED DESCRIPTION

The following section describes an example computer system that supports verification of conformance of graphical output data to a convention.

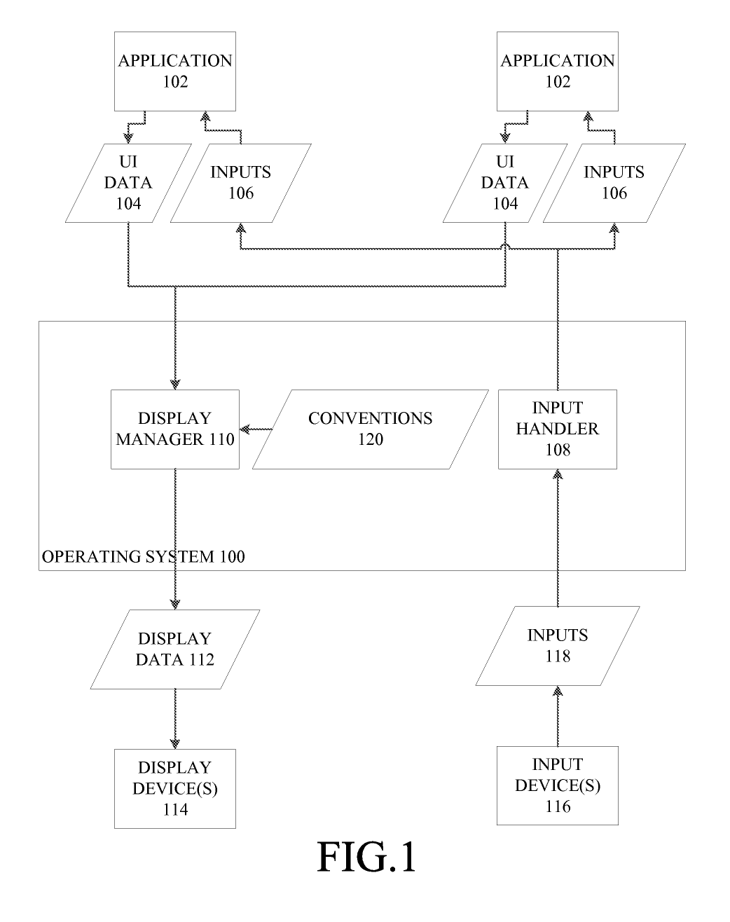

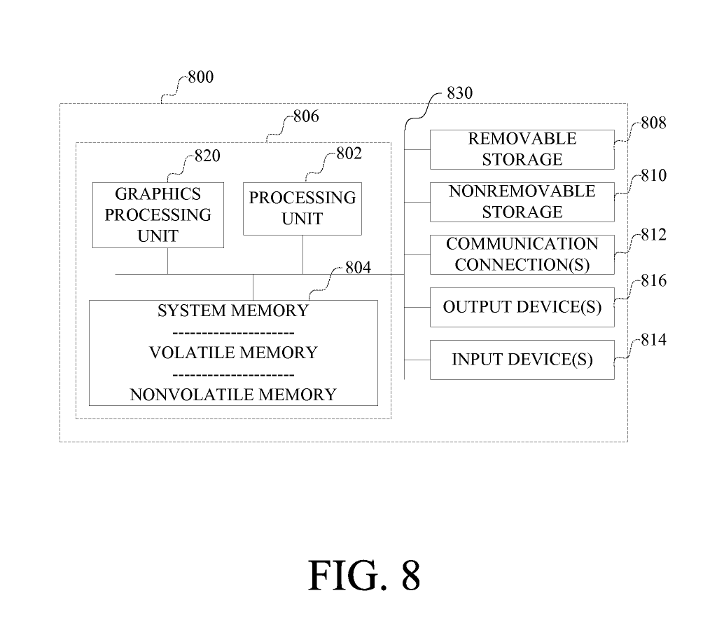

Referring to FIG. 1, an example implementation of a computer system includes an operating system 100, which is a computer program running on a computer that manages access to the various resources of the computer by applications 102. There may be multiple applications 102. The computer is implemented as described in connection with FIG. 8 below. The various resources include memory, storage, input devices and output devices, such as display devices 114 and input devices 116.

The computer can be any type of general-purpose or special-purpose computer, such as a tablet computer, hand held computer, smart phone, laptop or notebook computer, wearable computing device, or any other computing device that provides graphical output data to an output device, such as a display or printer, regardless of size or environment, more details and examples of which are discussed below in connection with FIG. 8.

In the example implementation described in connection with FIGS. 1 through 7, the graphical output data is part of a graphical user interface for an application running on a computer. In this example, the graphical output data is displayed on a display device which is part of a user interface through which a user is using the application. Thus, graphical data to be rendered for output, in this example, is referred to as user interface data. In other example implementations, the graphical output data can be directed to any other output device, such as a printer. In the case of a printer, the graphical data to be rendered for output may be print data that will be rendered by a rendering module that is part of a printer driver to product graphical output data to be directed to a printer.

In the example implementations in FIG. 1, the operating system includes a display manager 110 that receives user interface data 104 from applications 102. The user interface data is a set of instructions to render display data. The display manager 110, given this user interface data 104, renders it to provide display data 112, which is provided to display devices 114. A display device 114 may be a display connected to the computer running the operating system 100 or can be itself part of another computer that receives the display data 112 from the computer running operating system 100. Similarly, an application may be running on a separate computer from an application that renders the user interface data for that application, as is the case in browser-based applications. A user that is viewing the display device 114 also can manipulate one or more input device(s) 116 to provide various inputs 118 to the applications 102. An input handler 108 in the operating system generally handles distribution of inputs 118 as input 106 to the various applications.

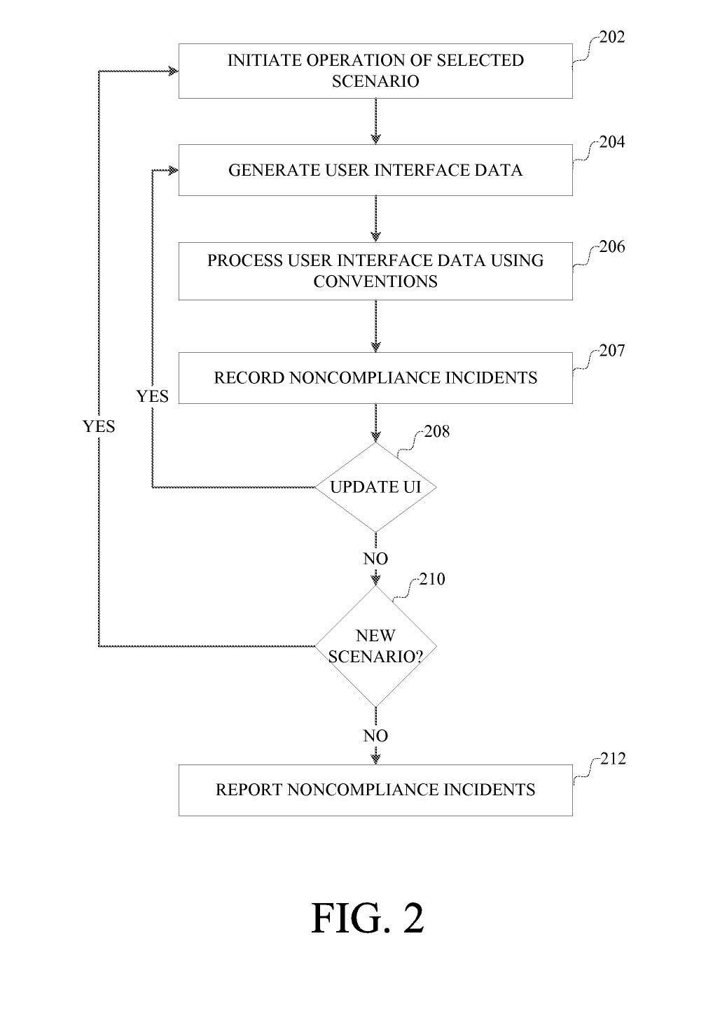

In this environment, the conformance of the display data 112 to conventions defined for display data of the graphical user interfaces of the applications 102 can be verified. A tester, e.g., an individual person, accesses the computer to use the applications 102, through the graphical user interfaces of these applications 102, using display devices 114 and input devices 116. A testing process used by such a tester is described in more detail below in connection with FIG. 2.

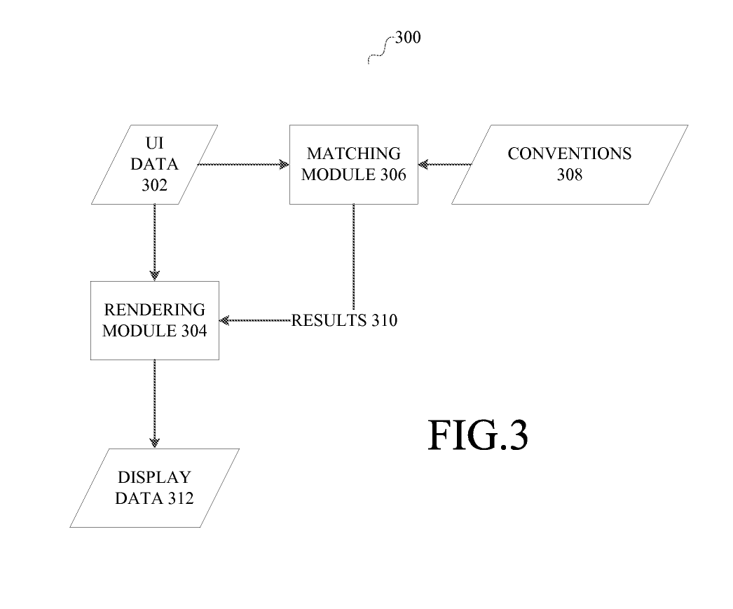

As will be described in more detail below in connection with FIGS. 3-7, the display manager 110 uses conventions 120 to verify that the display data 112 in a graphical user interface, such as text, images and other user interface elements, conforms to the conventions. In particular, the user interface data 104 is processed to determine if the display data 112, as rendered in accordance with data 104, conforms to the conventions 120. The display data 112 is then rendered based on this determination of conformance, such that the rendered display data visibly differentiates conforming display data from nonconforming display data. For example, text that conforms to the specified font type, font size and font color can be displayed in one color, and text that is not conforming can be displayed with another color. Note that the display data 112 is not rendered as instructed by the user interface data 104, because the display data 112 visibly indicates this conformance, for example by having a particular color.

Referring to FIG. 2, an example of a testing process for a graphical user interface will now be described. A similar process can be used for verifying graphical output data directed to a printer or other output device. In general, a tester causes an application 102 to initiate 202 operation in a selected user scenario. For example, the tester may invoke a search command through a user input 106. The application 102 responds to the user input 106 to generate 204 user interface data 104 that includes information responsive to the invoked command. The display manager 110 processes 206 the user interface data 110 to generate the display data 112 using the conventions 120, which is in turn caused to be displayed on the display devices 114. The tester may continue to provide user input in this scenario, which may cause the user interface to be updated, as indicated at 208, and the processes of generating user interface data and rendering the user interface data using the conventions 120 repeats. If the display data 112 indicates nonconformance of display data to the convention, then such an incident can be recorded 207. The tester may switch to another testing scenario, as indicated at 210, and the processes of generating user interface data and rendering the user interface data using the conventions 120 repeats. The tester may have a variety of ways of recording and tracking errors, i.e., noncompliance of the display data to the standards, which can be reported to software developers so that the applications can be modified to correct the graphical user interface display data. The running of scenarios, provision of user input, and recording and reporting of compliance or noncompliance of the user interface data, can be semi-automated or even automated depending on the implementation. Testing often involves creating scripts that automate the interaction with an application.

A data flow diagram of an example implementation of the display manager will now be described in connection with FIG. 3.

In this example implementation, the display manager 300 includes a rendering module 304 that has an input to receive user interface data 302 from an application. A matching module 306 also has an input to receive the user interface data 302. The matching module has another input to receive the conventions 308. The conventions 308 can be defined, for example, using rules for processing the user interface data 302 or any other information suitable to allow the matching module 306 to compare the user interface data 302 to the conventions 308. The matching module has an output to provide results 310, which results indicate whether the user interface data 302, when rendered, produces display data 312 that conforms to the convention. For example, in response to user interface data, the rendered display data can have a first color if the display data is conforming to the convention, and can have a second color if the display data is not conforming to the convention. The first and second colors are substantially different from each other so as to allow a person viewing the display to readily differentiate between conforming and nonconforming display data.

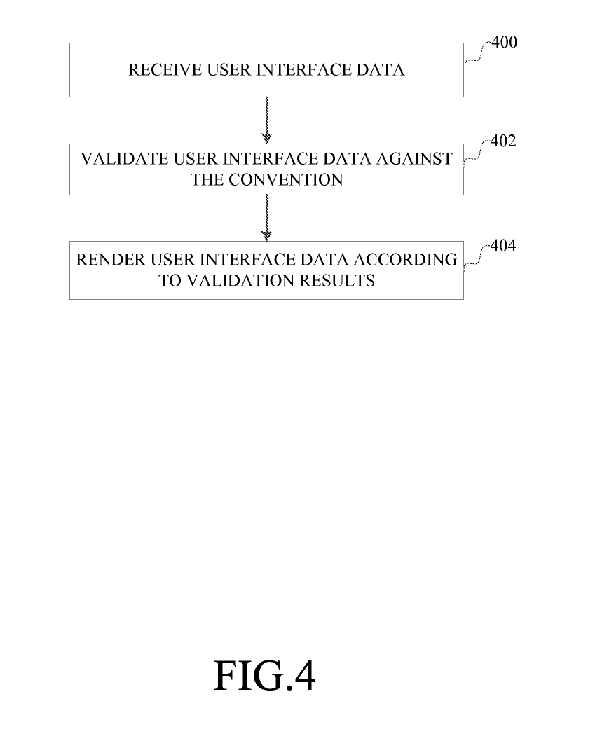

Referring now to FIG. 4, a flowchart describing operation of this example implementation will now be described.

The matching module receives 400 user interface data and validates 402 the user interface data against the convention. The validation performed is dependent on the nature of the convention data, and can involve processing a rule, looking up values in a lookup table, comparing of values, and the like. The matching module outputs results to the rendering module, which renders 404 the user interface data according to the validation results. The process of FIG. 4 can be included as part of a larger testing process, such as described in FIG. 2, which involves recording and reporting of user scenarios, user inputs, user interface data and conformance or nonconformance of the display data of the graphical user interface to the convention.

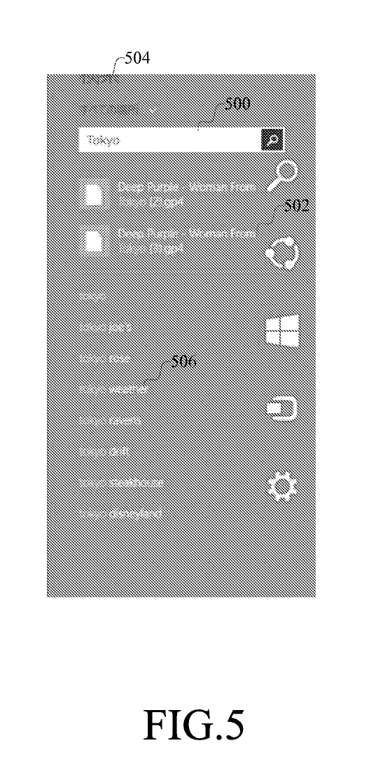

An example graphical user interface of a search application is shown in FIG. 5. In this example, the user interface data defines several elements that appear in the rendered display data, including a text box 500, which reflects text entered by a user for a search, and file name results for the search as indicated at 502. Search suggestions are shown at 506. Informational text relating to this search interface is provided at 504. In this example, the language of the informational text is in Japanese and the search results and suggestion are in English. In this example, conforming text is shown in red, whereas nonconforming text is shown in grey. Without knowing what characters in a given font look like, and without knowing characters used in either of the English or Japanese languages, any individual can readily determine that the fonts used in the search text box 500 and the informational text 504 conforms to convention specified for this application. Also, that individual can readily determine that the fonts used in the search suggestions 506 and the search results 502 do not conform to the convention. This fact can be recorded, whether automatically by the renderer, or by the individual, and then reported to a developer of the application, in response to which the application can be modified so as to change the font for the search results and search suggestions.

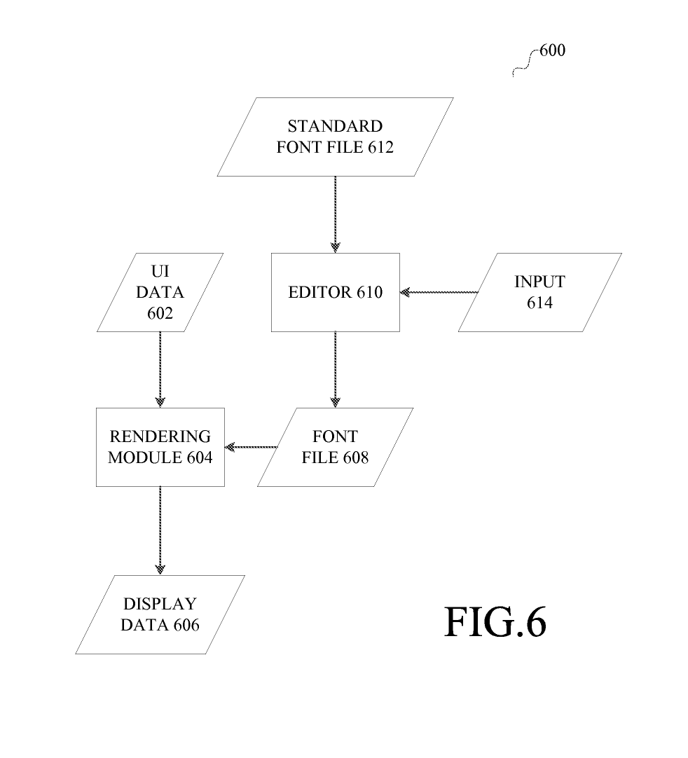

A data flow diagram of another example implementation of the display manager will now be described in connection with FIG. 6. In this example, the conventions relate to font properties, such as font type (or face), size, weight, style, color, scaling factor, layers, names, and the like, which are represented by data in a font file 608. Any font properties that can be set in a font file and specified within a convention can be verified using the techniques described herein.

In particular, a conventional font file 612 that would normally be used by the rendering module 604 is modified, using an editor 610 and input 614. The font file 612 generally includes data for a font type, including bitmaps of glyphs of characters in that font, for different sizes and colors and other variable parameters of the font. A developer may edit the font file 612, for example using a standard text editor, to make modifications to the font file 612. The modified font file 608 is then used by the rendering module 604 to render user interface data 602 to produce the display data 606.

The modifications to be made to the font file generally include changing the color information such that the glyph returned by the font file to the rendering module, in response to a given character in a given font, has a first color if the character conforms to the convention, and has a second color if the character does not conform to the convention. The first and second colors are substantially different from each other so as to allow a person viewing the display to readily differentiate between conforming and nonconforming fonts. For example, the first and second colors can be of different hues, or in substantially different locations in a color space. Thus, the display data 606 visibly differentiates conforming from nonconforming text when displayed on a display.

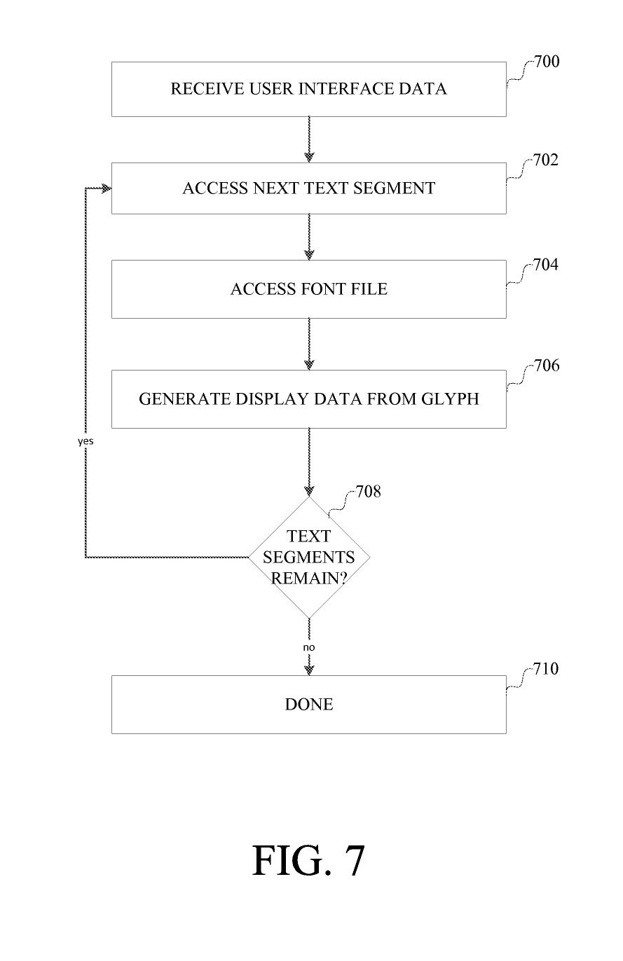

Referring now to FIG. 7, a flow chart describing operation of this example implementation will now be described. Given a modified font file, the rendering module receives 700 user interface data to be rendered. Any text in the user interface data is presumed, for the sake of this example, to be presented as a set of text segments, with each text segment including a string of characters, a font type, a font size and any other data specifying the font. Any next text segment in the user interface data is accessed 702. The font file is then accessed 704 to obtain glyph data for the specified font. If the text segment is conforming to the convention, this glyph data will be in a first color; if the text segment is not conforming to the convention, this glyph data will be in a second color. The glyph data is used in generating 706 the display data. If any text segments remain, as indicated as 708, the process repeats for the next text segment. Otherwise, text processing for this set of user interface data is done, as indicated at 710.

The process of FIG. 7 can be included as part of a larger testing process, such as described in FIG. 2, which involves recording and reporting of user scenarios, user inputs, user interface data and conformance or nonconformance of the display data of the graphical user interface to the convention. Such a testing process can be performed using any rendering of graphical data for an output device.

It is also possible to detect, and thus convey to a tester, whether rendered graphical output data is partially conforming (or partially nonconforming). For example, given two font properties, text can be rendered in one color if both properties are conforming, in a second color if neither property is conforming, or with a combination of features if one property is conforming and another is not. For example, a “halo” effect in a second color can surround text in first color to indicate such partial conformance. Other features can be used in the rendered graphical output data to indicate partial conformance so long as such features can be visibly distinguishing when the rendered graphical output data is presented on an output device.

By detecting conformance of rendered graphical output data to a convention at the time of rendering, and providing rendered graphical output data that visibly differentiates conforming from nonconforming display data when presented on an output device, many testing problems are addressed. For example, a person can more easily tell whether text conforms to specified font properties, such as an acceptable font type, font size or color, even if he or she is not familiar with the characters of the language of the text and how those characters should appear in a given font.

Having now described an example implementation, FIG. 8 illustrates an example computer with which the various components of the system of FIGS. 1-7 can be implemented. The computer can be any of a variety of general purpose or special purpose computing hardware configurations. Some examples of types of computers that can be used include, but are not limited to, personal computers, game consoles, set top boxes, hand-held or laptop devices (for example, media players, notebook computers, tablet computers, cellular phones, personal data assistants, voice recorders), server computers, multiprocessor systems, microprocessor-based systems, programmable consumer electronics, network PCs, minicomputers, mainframe computers, and distributed computing environments that include any of the above types of computers or devices, and the like.

With reference to FIG. 8, an example computer 800 includes at least one processing unit 802 and memory 804. The computer can have multiple processing units 802. A processing unit 802 can include one or more processing cores (not shown) that operate independently of each other. Additional co-processing units, such as graphics processing unit 820, also can be present in the computer. The memory 804 may be volatile (such as dynamic random access memory (DRAM) or other random access memory device), non-volatile (such as a read-only memory, flash memory, and the like) or some combination of the two. This configuration of memory is illustrated in FIG. 8 by dashed line 806. The computer 800 may include additional storage (removable and/or non-removable) including, but not limited to, magnetically-recorded or optically-recorded disks or tape. Such additional storage is illustrated in FIG. 8 by removable storage 808 and non-removable storage 810. The various components in FIG. 8 are generally interconnected by an interconnection mechanism, such as one or more buses 830.

A computer storage medium is any medium in which data can be stored in and retrieved from addressable physical storage locations by the computer. Computer storage media includes volatile and nonvolatile memory, and removable and non-removable storage media. Memory 804 and 806, removable storage 808 and non-removable storage 810 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

Computer 800 may also include communications connection(s) 812 that allow the computer to communicate with other devices over a communication medium. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. Communications connections 812 are devices, such as a network interface or radio transmitter, that interface with the communication media to transmit data over and receive data from communication media.

Computer 800 may have various input device(s) 814 such as a keyboard, mouse, pen, camera, touch input device, and so on. Output device(s) 816 such as a display, speakers, a printer, and so on may also be included. All of these devices are well known in the art and need not be discussed at length here. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye , and gaze tracking, immersive augmented reality and virtual reality systems, all of which provide a more natural interface, as well as technologies for sensing brain activity using electric field sensing electrodes (EEG and related methods).

The various storage 810, communication connections 812, output devices 816 and input devices 814 can be integrated within a housing with the rest of the computer, or can be connected through input/output interface devices on the computer, in which case the reference numbers 810, 812, 814 and 816 can indicate either the interface for connection to a device or the device itself as the case may be.

Each component (which also may be called a “module” or “engine” or the like), of a system such as described in FIGS. 1-______ above, and which operates on a computer, can be implemented using the one or more processing units of the computer and one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures.

This computer system may be practiced in distributed computing environments where operations are performed by multiple computers that are linked through a communications network. In a distributed computing environment, computer programs may be located in both local and remote computer storage media.

Alternatively, or in addition, the functionality of one or more of the various components described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

It should be understood that the subject matter defined in the appended claims is not necessarily limited to the specific implementations described above. The specific implementations described above are disclosed as examples only.

What is claimed is:

1. A process comprising:
receiving first data into memory, the first data including instructions to render graphical output data for a computer,
receiving second data into memory, the second data indicating conventions for rendered graphical output data;
processing the instructions to determine if graphical output data rendered in accordance with the instructions conforms to the conventions; and
rendering the graphical output data in accordance with the instructions and based on the determination, such that the rendered graphical output data visibly differentiates conforming from nonconforming graphical output data when presented on an output device.

2. The process of claim 1, wherein the graphical output data includes characters in a font type and the conventions include acceptable font types.

3. The process of claim 1, wherein the graphical output data includes characters in a font size and the conventions include acceptable font sizes.

4. The process of claim 1, wherein the graphical output data includes characters in a color and the conventions include acceptable colors of characters.

5. The process of claim 1, wherein the graphical output data is display data for a graphical user interface for an application or operating system on the computer.

6. The process of claim 5, wherein the instructions are received from two or more applications on the computer.

7. The process of claim 6, wherein the processing is performed by a display manager of an operating system.

8. The process of claim 7, further comprising recording information about any instructions to render graphical output data if the graphical output data does not conform to the conventions.

9. The process of claim 1, wherein processing includes rendering the instructions using a font file, wherein glyphs for set of font sizes, types and colors, conforming to the conventions, are encoded in a color that, when rendered, indicate conformance to the user.

10. The process of claim 1, further comprising recording information about any instructions to render graphical output data if the graphical output data does not conform to the conventions.

11. A computer program product, comprising:
one or more computer storage media;
computer program instructions stored on the one or more computer storage media which, when processed by a computer, configure the computer to implement a rendering module having an input to receive graphical data from the memory, including instructions to render graphical output data and an input to receive data from the memory indicating conventions for rendered graphical output data, the rendering module processing the instructions to determine if graphical output data rendered in accordance with the instructions conforms to the conventions, and rendering the graphical output data both in accordance with the instructions and based on the determination, such that the rendered graphical output data visibly differentiates conforming from nonconforming graphical output data when presented on an output device.

12. The computer program product of claim 11, wherein the graphical output data is display data for a graphical user interface for an application or operating system on the computer.

13. The computer program product of claim 12, wherein the instructions are received from two or more applications on the computer.

14. The computer program product of claim 13, wherein the processing is performed by a display manager of an operating system.

15. The computer program product of claim 14, further comprising recording information about any instructions to render graphical output data if the graphical output data does not conform to the conventions.

16. A computer system, comprising:
a processor;
a memory that stores data and is connected to communicate data with the processor;
the processor being configured to implement a rendering module having an input to receive graphical data from the memory, including instructions to render graphical output data and an input to receive data from the memory indicating conventions for rendered graphical output data, the rendering module processing the instructions to determine if graphical output data rendered in accordance with the instructions conforms to the conventions, and rendering the graphical output data both in accordance with the instructions and based on the determination, such that the rendered graphical output data visibly differentiates conforming from nonconforming display data when presented on an output device.

17. The computer program product of claim 16, wherein the graphical output data is display data for a graphical user interface for an application or operating system on the computer.

18. The computer program product of claim 17, wherein the instructions are received from two or more applications on the computer.

19. The computer program product of claim 18, wherein the processing is performed by a display manager of an operating system.

20. The computer program product of claim 19, further comprising recording information about any instructions to render graphical output data if the graphical output data does not conform to the conventions.
